(19) United States
(12) Patent Application Publication
(10) Pub. No.: US 2020/0353848 A1
(43) Pub. Date: Nov. 12, 2020

(54) VEHICLE TRENCH COVERS

(71) Applicant: William C. Knaust, Brush Prairie, WA (US)

(72) Inventor: William C. Knaust, Brush Prairie, WA (US)

(21) Appl. No.: 16/406,719

(22) Filed: May 8, 2019

(51) Int. Cl. B60N 2/36; B60R 13/01; B60R 5/04

(52) U.S. Cl. CPC B60N 2/36; B60R 13/013; B60N 2002/363; B60R 5/045; B60R 5/041

(57) ABSTRACT

A rear seat gap closure panel for a vehicle is presented. The rear seat gap closure panel has a first panel with top and bottom edges. The bottom edges are attached to a leaf spring and a second panel with a top and bottom edge also attached to a leaf spring. The first and second panels with the first and second leaf springs are positioned end-to-end and connected with a single elongated leaf spring pin passing through both the first and second leaf springs, allowing the first and second panels to fold separately about the connected first and second leaf springs. The rear seat gap closure panel also has a plurality of fastening brackets attached to the leaf springs, where the fastening brackets are constructed to permanently mount the seat gap closure panel in the vehicle closing gaps between rear seats when the rear seats are folded.

### FIELD OF THE INVENTION

This invention relates to trench covers. More particularly, it relates to cargo trench covers.

### BACKGROUND

Currently, automotive vehicles such as sport utility vehicles use a simple, static lid/cover to cover a rear, lower cargo area. Typically, the rear seat is a fixed mount arrangement i.e., the seat does not slide rearwardly or forwardly, but instead has a static position in the vehicle. In sport utility vehicles, such as the Jeep Wrangler Unlimited vehicle, when one or both of the back seats are folded down to utilize the cargo area, a trench or gap is created. The trench or gap is unsightly, unsafe and presents a hazard for pets or others that may be in the back seat/cargo area.

There is a desire to cover trench areas when the seat is folded down to be used as a cargo area. The desired cover would securely attach to the factory hardware and would be moved into position to cover the gap when either or both rear seats are folded down to increase cargo space.

The lid/cover often times is not connectable to the factory hardware and is not securely attached, therefore a need exists for a lid/cover that can attach to the factory hardware securely.

Further, aesthetics play an increasingly important role in automotive vehicle design. Therefore, any proposed solution must be adaptable, intuitive, easy to use, and also aesthetically pleasing. Consequently, a need exists for a cargo area cover, and one particularly adaptable for the gap created when one or both rear seats are folded down that meets these needs and others in an effective, reliable, easy-to-manufacture, cost-efficient, and stylish manner.

### BRIEF DESCRIPTION OF THE DRAWINGS

FIG. 1 is a view of the top of the exemplary seat trench cover.

FIG. 2 is a view of the bottom of the exemplary seat trench cover.

FIG. 3 is a view of the components of the exemplary seat trench cover.

FIG. 4 is a side view of the exemplary seat trench cover.

FIG. 5 is a standing view of the exemplary seat trench cover from the top side.

FIG. 6 is a standing view of the exemplary seat trench cover from the bottom side.

FIG. 7 is a standing view of the exemplary seat trench cover from the side view.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

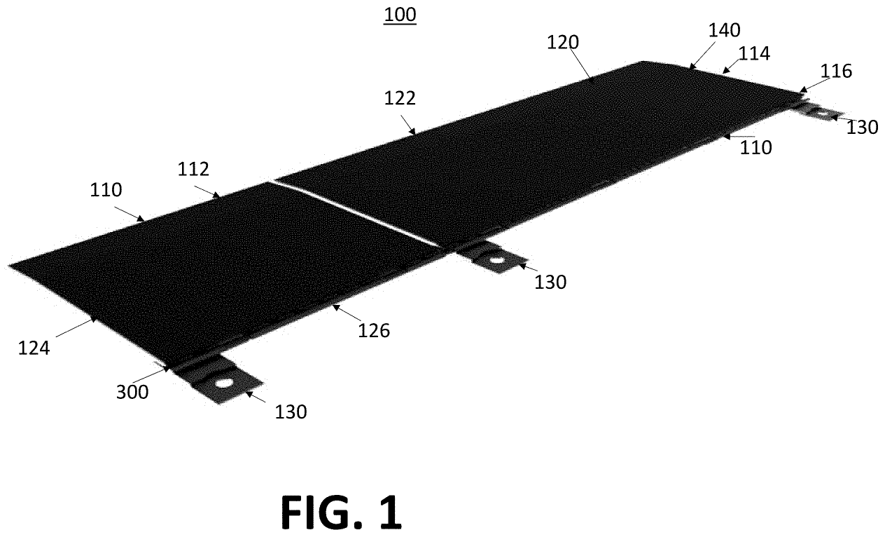

Referring to FIG. 1, a top view of the exemplary seat trench cover 100 for a vehicle is presented. The seat trench cover 100 has a first panel 110, a second panel 120 and a hinge assembly 130. The vehicle may be of any type of vehicle such as a Jeep Wrangler™ Unlimited, etc. The first panel 110 and the second panel 120 may be of any light weight, strong material such as aluminum or other like material.

The first panel 110 has a top side 114 and the second panel 120 has a top side 124. The top side 114, 124 are sealed and painted with a material which has a strong and lasting quality to avoid damage and protect the contents in the trench. The top side 114, 124 may be painted any color as desired, or covered with a material such as fabric.

The first panel 110 and the second panel 120 of the seat trench cover 100 are of two different lengths where the first panel 110 of the seat trench cover 100 is between two (2) to two and three tenths (2.3) the length of the second panel 120 of the seat trench cover. For example, to fit a typical trench in a vehicle, the first panel 110 would be approximately twenty-seven and one quarter (27.25) inches in width. The width of the second panel 120 is approximately twelve (12) inches and the height of the first panel 110 and the second panel 120 is approximately ten and three hundred twenty-two (10.322) inches.

The first panel 110 has an upper edge 112 and the second panel 120 has an upper edge 122, where the upper edge 112 of the first panel 110 and the upper edge 122 of the second panel 120 are substantially along the same plane such that a straight appearance is presented.

The first panel 110 and the second panel 120 may be flat or other shape as necessary for aesthetic purposes or for full closure of the trench area of the vehicle. The first panel 110 and the second panel 120 are substantially planer to each other and have a single bend 140 substantially near the upper edge 112, 122 of the of the first panel 110 and the second panel 120 along a predetermined axis parallel to the upper edge 112, 122.

For example, the axis parallel to the upper edge 112, 114 is between nineteen percent and twenty-one percent (19%-21%) of the height down from the upper edge 112, 114.

The first panel 110 has a lower edge 116 and the second panel 120 has a lower edge 118. The lower edges 116, 126 are planer to each other. The lower edge 116, 126 are coupled to the assembly 300. The assembly 300 may be coupled to the lower edge 116, 126 using spot welds, screws, etc.

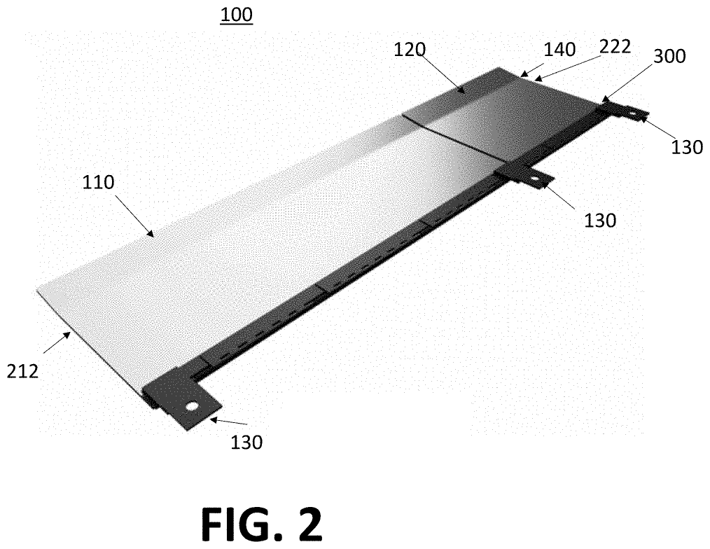

Moving now to the FIG. 2, a bottom side view of the exemplary seat trench cover 100 is presented. The first panel 110 has a bottom side 212 and the second panel 120 has a bottom side 222. The bottom side 212, 222 have the single bend 140. The end brackets 130 are coupled to the first panel 110 and second panel 120 as described earlier and are the most visible in this example of the assembly 300. The bottom side 212, 222 is generally not painted nor having fabric but may as desired by the user.

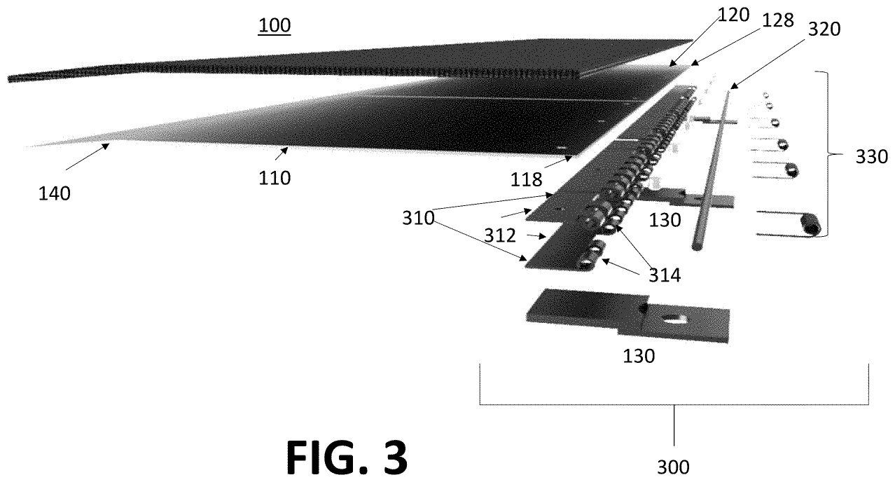

Referring now to FIG. 3, the assembly 300 of the exemplary seat trench cover 100 is presented. The first panel 110 and the second panel are coupled and shown. The assembly 300 has a plurality of large leaf hinges 310. The large leaf hinges 310 have a flat side 312 and an embossed side 314 for receiving spring legs.

The large leaf springs 310 are coupled to one end of the plurality of end brackets 130. The other end of the plurality of end brackets 130 are coupled to the first panel 110 and second panel 120. Generally, spot welding is performed to couple the end brackets 130 to the first panel 110 and the second panel 120. The large leaf springs 310 are coupled to the end brackets most generally by spot welds.

A hinge pin 320 is coupled to the end brackets 130. The hinge pins are coupled to the embossed edge 314 of the large spring leaf hinges 310 by inserting spring hinges 330 into the receiving embossed edge 314 and securing the spring hinges 330. The spring hinges 330 may also be torsion hinges.

Thus, when the first panel 110 and the second panel 120 are coupled to the assembly 300 to be placed on a seat trench for securely holding items in the trench and when stowed, they may provide a covering for the gap which is prevalent in the industry today.

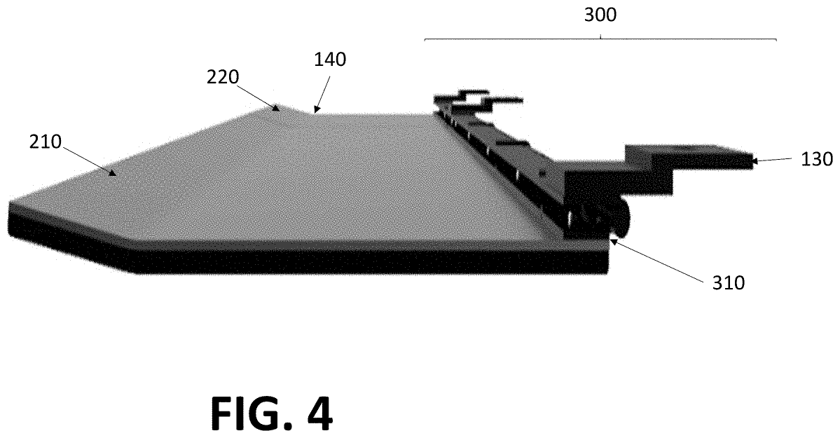

Moving now to FIG. 4, the seat trench cover 100 is shown from a side view. The seat trench cover 100 has the single bend 140 which is bent towards the bottom side 210, 220 of the seat trench cover 100. At the lower edge 116, 126, the assembly 300 is coupled. The coupling of the assembly 300 to the lower edge 116, 126 is most generally by spot weld but may be attached in any manner to secure the assembly 300 to the lower edge 116, 126. The large spring hinges 310 of the assembly 300 is coupled to the lower edge 116, 126 of the seat trench cover 100. The end brackets 130 are coupled to the large spring hinges 310 on the side opposite of the seat trench cover 100.

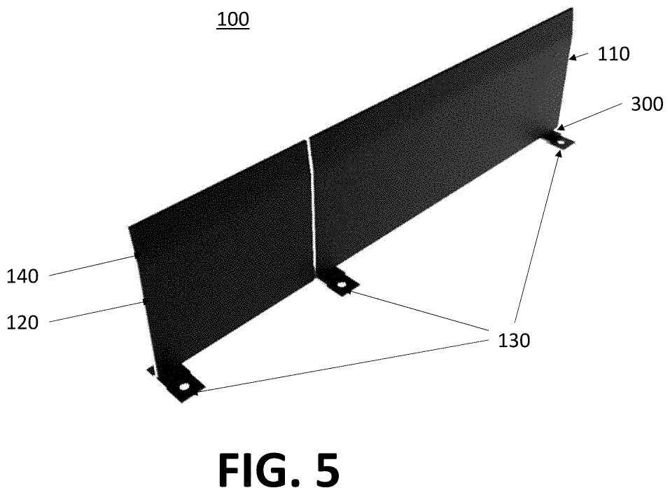

FIG. 5 shows a view where the assembly 300 has been adjusted such that the seat trench cover 100 would be in an open position. The first panel 110 and the second panel 120 are coupled to the assembly 300. The end brackets 130 would be coupled to the frame of the vehicle to secure the seat trench cover 100 to the vehicle and avoid the seat trench cover 100 from moving while in use.

Since FIG. 5 shows the view from the top side 114, 124 of the seat trench cover 100, the assembly 300 is not viewable. The single bend 140 is shown and the curvature is not discernable because of the bend away from the top side 114, 124 of the seat trench cover 100.

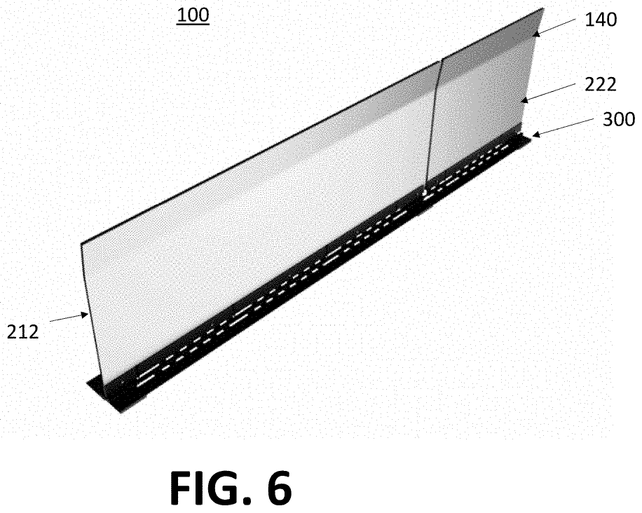

FIG. 6 shows a view where the assembly 300 has been adjusted such that the seat trench cover 100 would be in an open position from the bottom side 212, 222 of the seat trench cover 100. The first panel 110 and the second panel 120 are coupled to the assembly 300. Although not viewable from the view of the bottom side 212,222, the end brackets 130 would be coupled to the frame of the vehicle to secure the seat trench cover 100 to the vehicle and avoid the seat trench cover 100 from moving while in use.

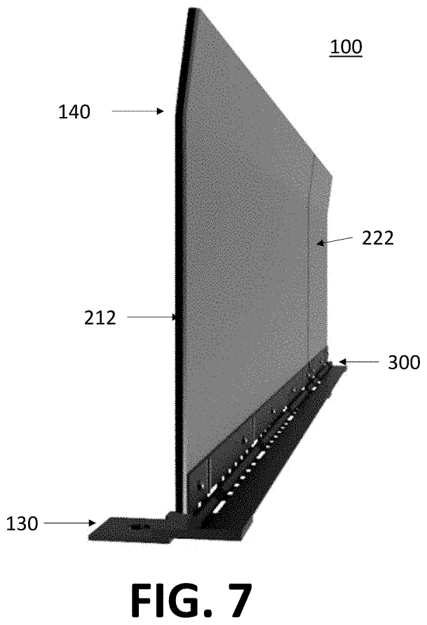

FIG. 7 shows a side view of the bottom view of an open seat trench cover 100. The bottom side 212, 222 is shown with a single bend 140 in the seat trench cover 100. The large spring hinges 310 are coupled to the lower edge of the seat trench cover 100 most generally by using spot welds. The assembly 300 is thereby coupled to the seat trench cover 100. Further the end brackets 140 are coupled to the assembly 300 generally using spot welds. The end brackets 140 are further coupled to the vehicle to secure the seat trench cover 100 to the vehicle and to prevent the movement of the seat trench cover 100 or the vehicle from any mishap with the seat trench cover 100. No additional hardware is needed for the vehicle, the end brackets 140 are securely attached to the factory hardware of the vehicle.

Once the back seats have been folded. A user would remove the nuts/screws that connect the back seats to the vehicle. The seat trench cover 100 is then placed with the end brackets 140 over the position of the removed nuts/screws. The nuts/screws are then replaced to secure the seat trench cover 100 to the vehicle. The seat trench cover 100 is strong and durable and with the fabric being factory grade becomes seamless in the vehicle.

The seat trench cover 100 is useful when one or more fixed rear seats, such as those found on a Jeep Wrangler™ Unlimited, are folded down to increase cargo area of the Jeep Wrangler™ Unlimited. The gap or trench is covered by the seat trench cover 100 and is securely attached to the factory hardware of the Jeep Wrangler™ Unlimited.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A rear seat gap closure panel apparatus for a vehicle comprising:
a first panel having top and bottom edges attached on its bottom edge to a first leaf spring;
a second panel also having top and bottom edges attached on its the bottom edge to a second leaf spring;
wherein, the first and second panels with the first and second leaf springs are positioned end-to-end and connected together with a single elongated leaf spring pin passing through both the first and second leaf springs allowing the first and second panels to fold separately about the connected first and second leaf springs;
a plurality of fastening brackets attached to the leaf springs;
whereby, the fastening brackets are constructed to permanently mount the apparatus in the vehicle closing gaps between rear seats when the rear seats are folded down while allowing each rear seat to fold down independently.

2. The rear seat gap closure panel apparatus of claim 1 wherein each of the first and second panels are flat and approximately planer with a single bend near the upper edge to a predetermined angle along an axis parallel to the upper edge.

3. The rear seat gap closure panel apparatus of claim 2 wherein the first and second panels have height and width, and the axis parallel to the upper edge is between 19% and 21% of height down from the upper edge.

4. The rear seat gap closure panel apparatus of claim 2 wherein the predetermined angle is between 5 degrees and 15 degrees.

5. The rear seat gap closure panel apparatus of claim 1 wherein the first and second panels have height and width, and the width of the first panel is between 2.0 and 2.3 times the width of the second panel.

6. The rear seat gap closure panel apparatus of claim 5 wherein the width of the first panel is approximately 27.25 inches, the width of the second panel is approximately 12.00 inches, and the height of the first and second panels is approximately 10.322 inches.

7. The rear seat gap closure panel apparatus of claim 1 wherein the vehicle is a Jeep Wrangler™.

8. The rear seat gap closure panel apparatus of claim 1 wherein the first and second panels are attached to the first and second leaf springs respectively with spot welds.

9. The rear seat gap closure panel apparatus of claim 1 wherein the first and second panels are aluminum.

10. The rear seat gap closure panel apparatus of claim 1 wherein the first and second panels have a front and back surface, and the back surface is covered with fabric.

11. A Jeep™ vehicle rear seat gap closure device that includes two flat panels constructed to be mounted end-to-end in the vehicle with a plurality of mounting brackets, the panels being hingedly attached to the mounting brackets allowing the panels to fold downward independently with the rear seats when the rear seats are folded down; the flat panels constructed to cover a gap between the rear seats.

12. The Jeep™ vehicle rear seat gap closure device of claim 11 wherein the two flat panels are covered at least on one side with fabric.

13. The Jeep™ vehicle rear seat gap closure device of claim 11 wherein the two flat panels are aluminum.

14. The Jeep™ vehicle rear seat gap closure device of claim 11 wherein the two flat panels are attached to first and second leaf springs, wherein, a single leaf spring pin penetrates both the first and second leaf spring holding the panels together.

15. The Jeep™ vehicle rear seat gap closure device of claim 11 wherein the two flat panels comprise a first and second panel, and wherein the width of the first panel is approximately 27.25 inches, the width of the second panel is approximately 12.00 inches, and the height of the first and second panels is approximately 10.322 inches.

16. The Jeep™ vehicle rear seat gap closure device of claim 11 wherein the vehicle is a Jeep Wrangler™.

17. The Jeep™ vehicle rear seat gap closure device of claim 11 wherein the device is constructed to mount to existing seat bracket bolts in the vehicle.

18. The Jeep™ vehicle rear seat gap closure device of claim 14 wherein the first and second leaf springs cause the two flat panels to cling to the rear seats in any rear seat position.

19. A seat gap closure device constructed to mount behind and track folding rear seats of a vehicle, the device comprising:
at least one panel hingedly attached to a plurality of mounting brackets attachable to the vehicle behind the seats, wherein the panel is biased against the seats by a spring so that when the seats are folded down, the panel follows and maintains contact with the seats providing a flat cargo surface when the seats are folded down.

20. The seat gap closure device of claim 19 further comprising two panels each panel constructed to be biased against a separate rear seat.
